(19) United States
(12) Patent Application Publication
(10) Pub. No.: US 2002/0109723 A1
(43) Pub. Date: Aug. 15, 2002

(54) Method and system for displaying text in a fixed-sized information box on a viewing screen

(76) Inventors: Hong Yang, San Diego, CA (US); Jenny Su Chow, San Diego, CA (US)

Correspondence Address: Doyle B. Johnson, CROSBY, HEAFEY, ROACH & MAY, P.O. Box 7936, San Francisco, CA, 94120-7936, US

(21) Appl. No.: 09/781,718

(22) Filed: Feb. 12, 2001

(51) Int. Cl. G06F 3/14

(52) U.S. Cl. 345/764; 345/785

(57) ABSTRACT

A method and system for displaying text in a fixed-sized information box, which is displayed on a viewing device. If a text message is too large to fit in the information box based on a selected font size, a set-top box detects this condition and causes the information box to display as much of the text message as possible. The set-top box then cause the text message to scroll within the information box, thus allowing the user to view the remaining text. In this manner, the present method and system allows the user to view all relevant information, without limiting the length of the text messages or requiring the user to manually scroll through the text message.

### BACKGROUND OF THE INVENTION

1. Field of the Invention

The present invention relates generally to the field of on-screen displays and more particularly, to a method and system for displaying text in a fixed-sized information box on a viewing device used in conjunction with a set-top box.

2. Description of the Related Art

Many viewing devices, such as television sets or video monitors, are used with a set-top box. A set-top box is used to decode cable or satellite television broadcasts or internet data for display on the viewing device. Many set-top boxes also add other functions that a traditional viewing device does not have. For example, set-top boxes may provide on-screen program information. While viewing a television show, a user may peruse listings for upcoming movies that the user may want to view in the future. The movie listings are shown in an information box that occupies a fixed part of the television screen. The information box must not be too large or the user will not be able to see the television show. However, if the information box is too small (i.e. the font size is too small), the user may have difficulty reading the movie listing.

One possible solution to this problem is to place a limit on the amount of textual information that can be displayed. Of course, this means that the user will receive a very limited amount of information. Also, this method does not solve the problem of the user being able to see and read the textual information.

Another possible solution is to incorporate a scroll bar with the information box. On a typical computer interface, a user uses a scroll bar to scroll through text that is too large too fit on the whole display. This method could be applied to set-top boxes by allowing the user to manually scroll down the information by use of a remote control or buttons on the set-top box. This solves the problem associated with limiting the amount of information the user can receive. However, this solution requires extra effort by the user and is therefore undesirable. Thus, there is a need in the art for a means for displaying textual information on a viewing device that allows the user to increase the font size without limiting textual information for the user or requiring extra effort by the user.

### SUMMARY OF THE INVENTION

The present invention provides a method and system for displaying text in a fixed-sized information box, which is displayed on a viewing device. According to one embodiment of the present invention, if a text message is too large to fit in the information box based on a selected font size, the set-top box detects this condition and causes the information box to display as much of the text message as possible. The set-top box then cause the text message to scroll within the information box, thus allowing the user to view the remaining text.

When the end of the text message is reached, the set-top box causes the information box to display the beginning of the text message, and the message continues scrolling. This process continues until the user turns the information box off or selects another type of textual information to be displayed. In this manner, the present invention allows the user to view all relevant information, without limiting the length of the text messages or requiring the user to manually scroll through the text message.

### BRIEF DESCRIPTION OF THE DRAWINGS

The present invention will be readily understood by the following detailed description in conjunction with the accompanying drawings, wherein like reference numerals designate like structural elements, and in which:

FIG. 1 illustrates a set-top box used with a television set and remote control;

FIG. 2 illustrates a user selecting a small font size option;

FIG. 3 illustrates the resulting small font size of the textual information displayed in an information box;

FIG. 4 illustrates the user selecting a medium font size option;

FIG. 5 illustrates the resulting medium font size of the textual information displayed in the information box;

FIG. 6 illustrates the user selecting a large font size option;

FIG. 7 illustrates the resulting large font size which is too large for the information box to display all of the textual information;

FIG. 8 illustrates an example of the automatic scrolling function according to the present invention; and

FIG. 9 is a continuation of the example of the automatic scrolling function of the present invention.

### DETAILED DESCRIPTION OF THE INVENTION

The following description is provided to enable any person skilled in the art to make and use the invention and sets forth the best modes contemplated by the inventor for carrying out the invention. Various modifications, however, will remain readily apparent to those skilled in the art, since the basic principles of the present invention have been defined herein specifically to provide a method and system for displaying text in a fixed-sized information box on a viewing screen. Any and all such modifications, equivalents and alternatives are intended to fall within the spirit and scope of the present invention.

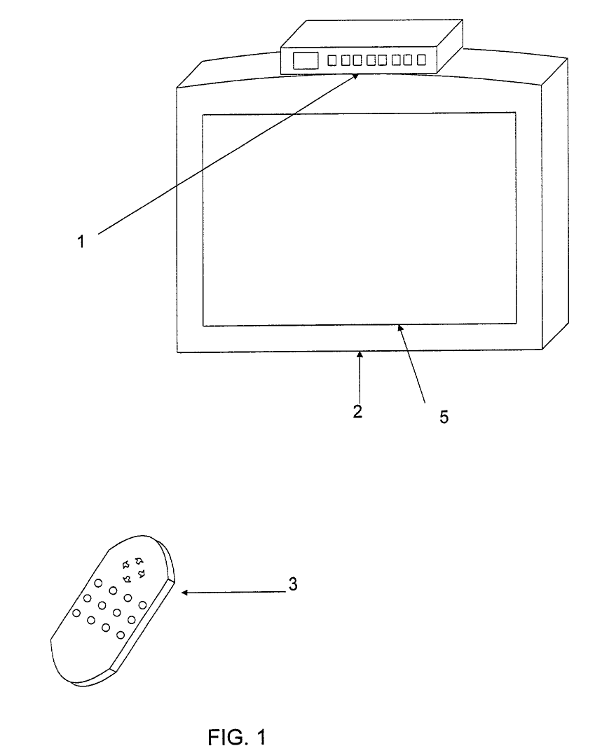

FIG. 1 illustrates a preferred embodiment of the present invention. In this embodiment, a set-top box 1 receives and decodes an antenna, cable, or satellite television signal for a television set 2 (this also could be a computer monitor, or any other type of viewing device). A user views television programs on the television screen 5 and controls the set-top box 1 by way of a remote control device 3.

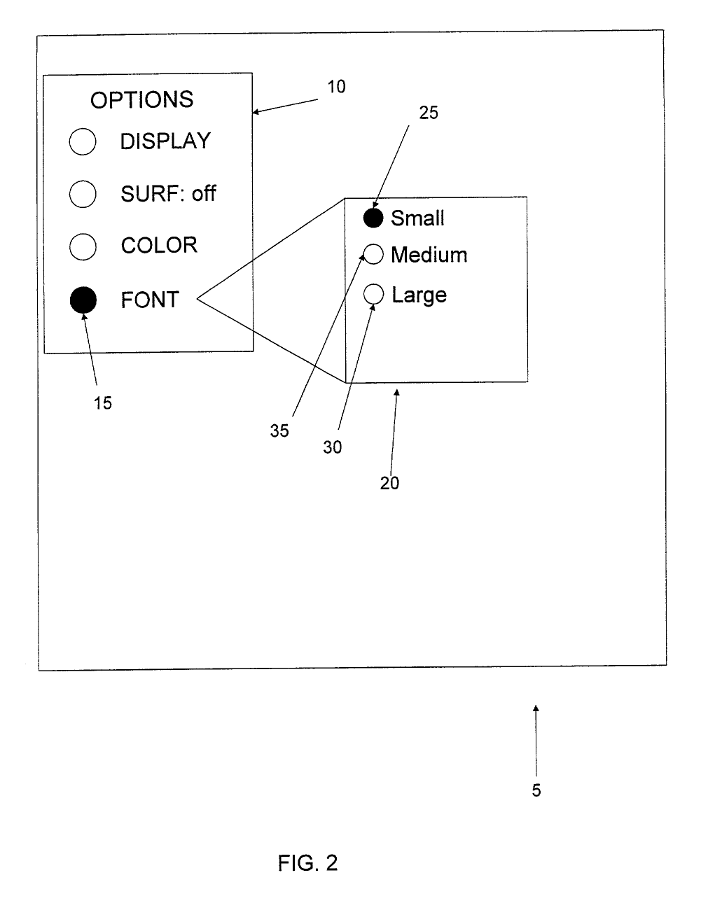

An example of the present invention is given in FIG. 2. Here, a user has accessed an options menu 10 for the set-top box 1 by using the remote control 3. The options menu 10 is displayed on the television screen 5. In this example, the user selects to change the font size by accessing a font menu 15, which will change the font size for text messages displayed by the set-top box 1 on the television screen 5. Selecting the font menu 15 brings up a font size option box 20. The user then selects the small font size 25.

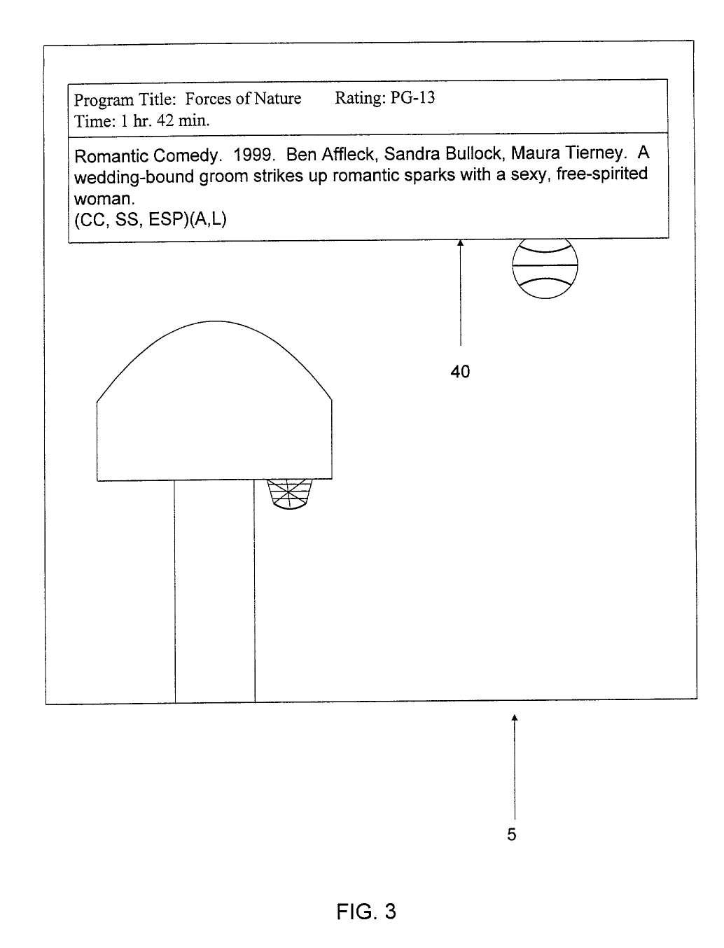

FIG. 3 illustrates the result of this selection. In this case, the user is searching through available movies during normal television viewing. A text message contains movie information that is displayed in only a portion of the television screen 5 in an information box 40 (also referred to as an information window, information screen, information display, or dialog box) so as to not obstruct normal television viewing. Typically, the information box 40 is restricted to a preset portion of the screen and does not change. The information box 40 can be used to display text messages about other subjects, for example, television listings or other set-top box functions. The rest of the television screen 5 continues displaying the television program the user is watching. If the television screen 5 is small, the text message in the information box 40 might be very small and difficult to read.

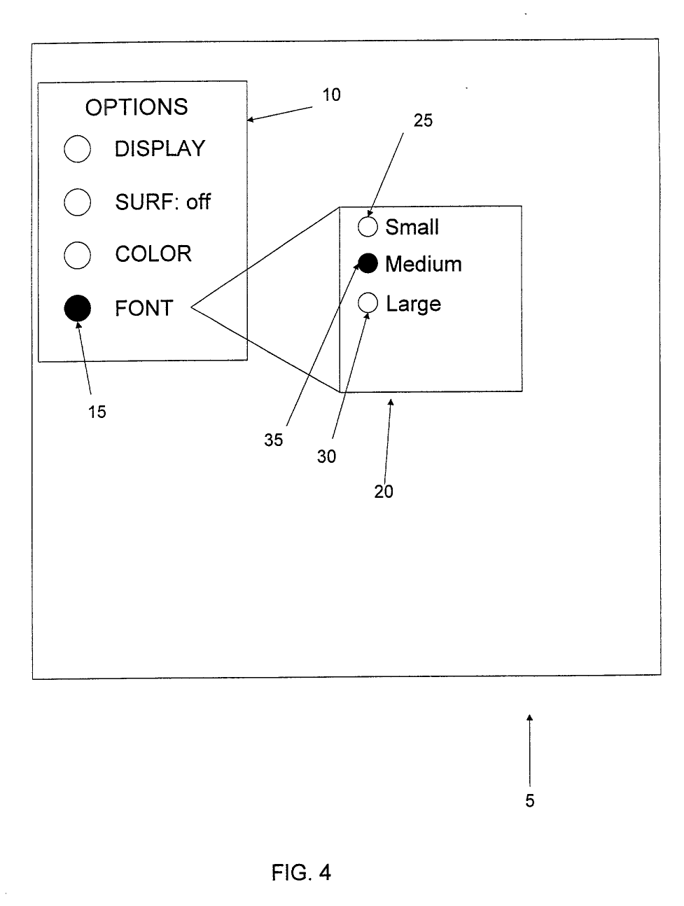

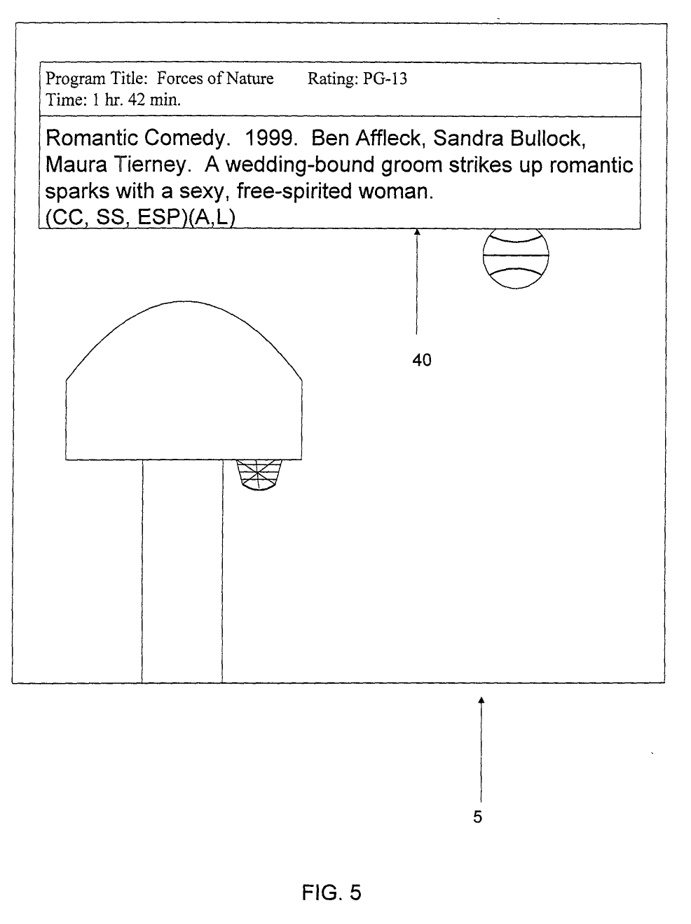

As illustrated in FIG. 4, the user chooses to increase the font size for text messages. The user selects the medium font size 35 from the font size option box 20. FIG. 5 illustrates the result of this selection. The size of the text message displaying the movie information is larger, as seen in the information box 40. The movie information formatted in the medium font size still fits in the information box 40 without any information being lost. If the movie information is still too small on the television screen 5 the user can again increase the font size.

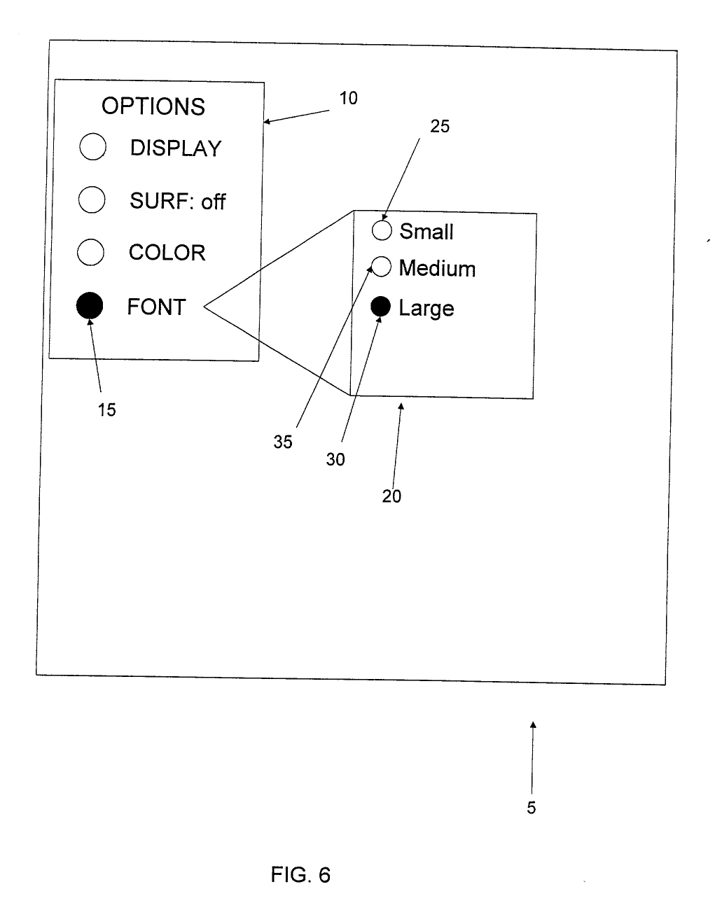

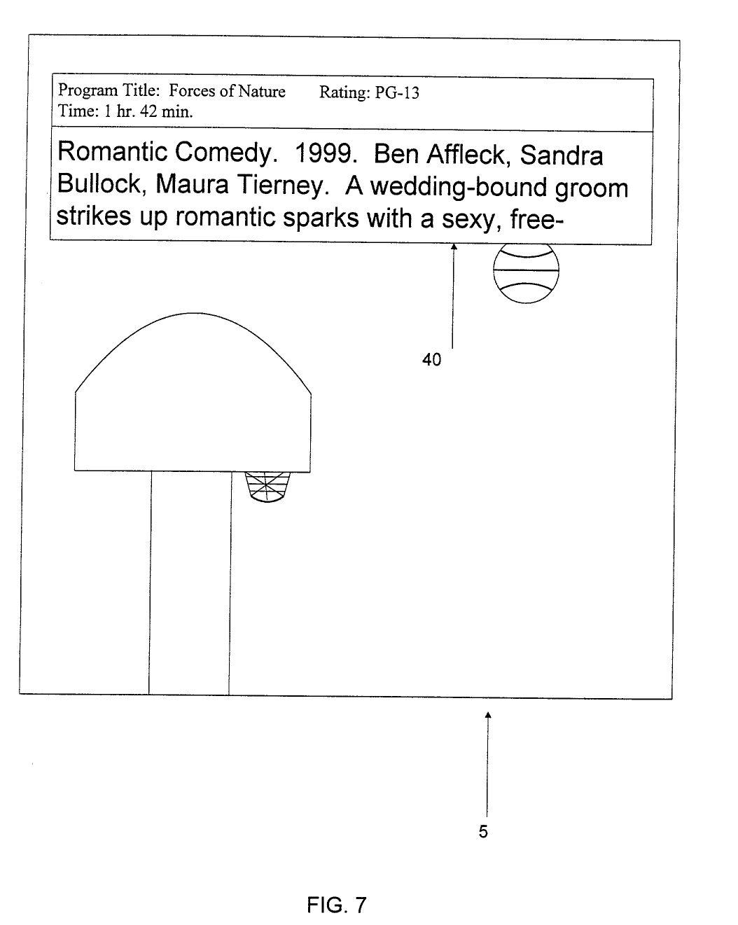

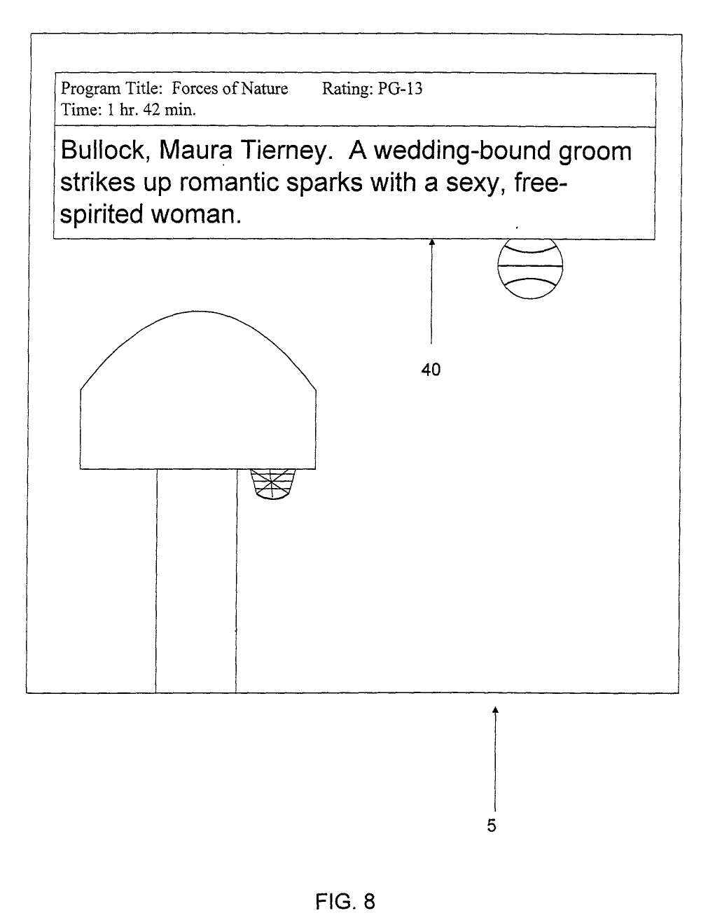

As illustrated in FIG. 6, the user selects the large font size 30 from the font size option box 20. This action results in the text message containing movie information that is too large to fit in the fixed-sized information box 40, as illustrated in FIG. 7. Once the set-top box 1 detects that all of the text message will not fit within the information box 40, it causes the information box 40 to display as much of the text message as possible. The set-top box 1 then starts a scrolling function to display the unviewed text. As illustrated in FIG. 8, after a short period of time, the set-top box causes the movie information to scroll one line down in the information box 40. The top line of the movie information leaves the information box 40 and the next line of the movie information appears.

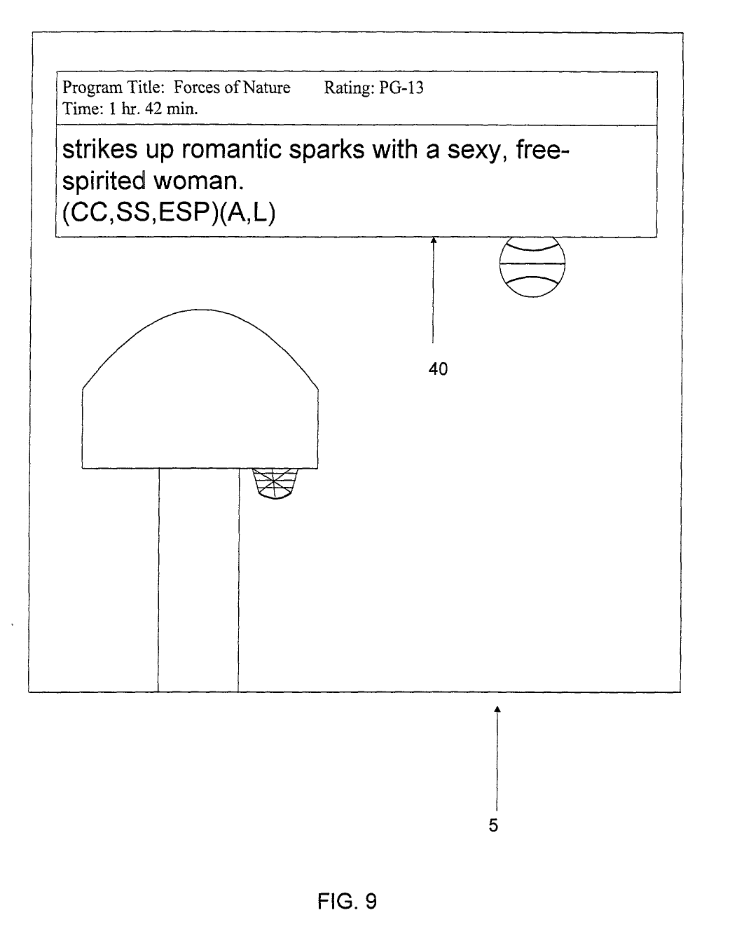

After a short period of time, the set-top box causes the movie information to scroll down one more line to allow the user to view the rest of the movie information, as illustrated in FIG. 9. At this point, all of the movie information has been viewed by the user. The scrolling starts over by next placing the first line of the movie information at the bottom of the end of the movie information seen in the information box 40. This process continues as before until another movie is selected or the user removes the information box 40. Thus, the present invention allows a user to increase the font size for easier reading without sacrificing any information that does not fit in the information box 40 or obstructing normal television viewing by increasing the information box 40 size. Of course, the set-top box would scroll through the movie information in a similar manner if the movie information did not fit in the information box 40 with the small font size 25 or the medium font size 35 selected.

Many variations of the present invention may be implemented. The type of option menus used and the progression through them may be changed. Examples of other variations include: gradually moving all of the text upwards and wrapping around the text instead of moving one line of the text off the screen at a time, displaying some lines at a time then replacing the displayed lines with new lines of the text message, having the television 2 (or other viewing device or control unit) implement the same scrolling function, or allowing the user to have some type of control over the scrolling.

Those skilled in the art will appreciate that various adaptations and modifications of the just-described preferred embodiments can be configured without departing from the scope and spirit of the invention. Therefore, it is to be understood that, within the scope of the appended claims, the invention may be practiced other than as specifically described herein.

What is claimed is:

1. A method for displaying text in a fixed-sized information box on a viewing screen, the method comprising:
selecting a desired font size for displaying text messages that are displayed in an information box on a viewing screen;
formatting a text message for display in the information box on the viewing screen according to the selected font size;
determining whether a length of the text message is too long to fit in the information box based on the selected font size;
displaying an amount of the text message that fits in the information box based on the selected font size; and
automatically scrolling through any remainder of the text message.

2. The method of claim 1, wherein when a last line of the text message is displayed, the text message continues scrolling from a beginning of the text message.

3. The method of claim 1, wherein a selection of available font sizes is preset.

4. A system for displaying text in a fixed-sized information box on a viewing screen, the system comprising:
a set-top box in electrical communication with a viewing screen;
an information box that displays text generated from the set-top box on a portion of the viewing screen;
a text message containing program information; and
a font size selector for selecting a font size for the text message;
wherein when the set-top box determines that the text message does not fit within the information box based upon a selected font size, the set-top box causes the information box to display only an amount of the text message that fits within the information box, and causes the text message to scroll within the information box.

5. The system of claim 4, wherein when a last line of the text message is displayed, the text message continues scrolling from a beginning of the text message.

6. The system of claim 4, wherein a selection of available font sizes is preset.
